(19) United States
(12) Patent Application Publication
(10) Pub. No.: US 2004/0071416 A1
(43) Pub. Date: Apr. 15, 2004

(54) Optical cable having an increased resistance to dry band arcing and method for its manufacture

(76) Inventor: Cristian I. Militaru, Greer, SC (US)

Correspondence Address: ECKERT SEAMANS CHERIN & MOLLETT, LLC, ALCOA TECHNICAL CENTER, 100 TECHNICAL DRIVE, ALCOA CENTER, PA, 15069-0001, US

(21) Appl. No.: 10/271,023

(22) Filed: Oct. 15, 2002

(51) Int. Cl. G02B 6/44

(52) U.S. Cl. 385/113

(57) ABSTRACT

An optical cable includes an outer jacket comprised of a cross-linked medium density polyethylene having at least 10% of an inorganic filler therein. The filler preferably comprises at least 75% by weight MgO. In particular embodiments, the ATH content of the filler is less than 1% by weight. Also disclosed is a method for manufacturing the cable in which a jacket of thermoplastic MDPE is extruded onto a cable core and subsequently cross-linked. Moisture activated cross-linking processes are specifically disclosed.

### FIELD OF THE INVENTION

This invention relates generally to optical cables. More specifically, the invention relates to an optical cable structure, and a method for cable fabrication, whereby dry band arcing of the cable is minimized.

### BACKGROUND OF THE INVENTION

Optical cables, also known as fiber optic cables, carry a data stream in the form of a modulated optical signal. Optical cables provide high speed, high bandwidth communication capability, and are in very widespread use. In many instances, a number of fiber optic strands are bundled into a single large communications cable; and often, such cables are strung along existing high voltage power distribution lines for reasons of expediency. The optical cables are electrically non-conducting; however, in this environment they are exposed to very high space potential levels and high axial electric field strength levels. Furthermore, they are exposed to ambient conditions of pollution, moisture and hot/cold cycles. This combination of factors can lead to the phenomenon referred to as “dry band arcing” also known as “tracking.”

Dry band arcing most typically occurs when a cable is exposed to moisture and pollution over a period of time so that its linear longitudinal resistance decreases to levels of approximately 10⁵ ohm/m as opposed to a resistance of 10⁹-10¹⁰ ohm/m for a new cable. The high electrical field imposed on the cable by an adjacent high voltage electrical line and the coupling capacity phase conductors-cable can induce a charge in the cable. This charge will slowly leak to earth, and this earth leakage current will heat the cable jacket. If the surface of the cable is moist, this heating will cause portions of the surface of the cable jacket to dry, thereby interrupting the film of moisture so as to form a dry band between two wet layers of water. This provides a high resistance zone, “the dry band,” between two lower resistance zones, “the wet layers”. The difference in potential over the dry band can cause the formation of an arc. The arc can go from a stable to an unstable regime and form a track on the cable jacket. This track can be longitudinal or transverse (circular) to the cable jacket axis and can damage and even cut through the cable jacket thereby causing failure.

Dry band arcing is a significant problem for optical cables, and the art has attempted to implement a number of solutions to this problem. For example, U.S. Pat. No. 5,526,457 discloses a grounding system for optical cables which attempts to reduce the magnitude of potential drop across the cable. Implementation of this system is labor and hardware intensive. Another hardware based solution for this problem is disclosed in U.S. Pat. No. 6,344,614 in which a shunting device is employed to carry away charge from a cable. U.S. Pat. No. 6,118,079 discloses a polymeric insulating material for preventing arcing which material includes a composite electrical insulator formed from alumina trihydrate and a polymer.

Despite the various attempts in the prior art to minimize problems of dry band arcing, no completely successful solutions have been developed. Ideally, any solution to the problem of dry band arcing should not be hardware intensive, should be easy to implement; and ideally, should not require any modification to cable deployment procedures and methods. As will be explained in detail hereinbelow, the present invention provides an optical cable which is resistant to dry band arcing. The cable of the present invention is manufactured utilizing conventional techniques, and is identical in form and function to prior art, non-protected cables. Consequently, use of the cable of the present invention does not require any special training on the part of workers, nor does it require the use of any additional hardware or tooling. These and other advantages of the cable of the present invention will be apparent from the drawings, discussion and description which follow.

### SUMMARY OF THE INVENTION

There is disclosed herein an optical communication cable having an increased resistance to dry band arcing. The cable comprises an elongated core member having at least one optical fiber extending along its length, and a jacket covering at least a portion of the length of the core member. The jacket is comprised of a body of cross-linked polyethylene having at least 10% by weight of an inorganic filler therein. In one preferred embodiment, the filler comprises at least 75% by weight MgO, and in a specific preferred embodiment the filler includes no more than 1% by weight of Al₂O₃. In particular embodiments, the polyethylene is medium density polyethylene.

Also disclosed herein is a method for the manufacture of the optical cable wherein an elongated core member having at least one optical fiber extending along its length has a jacket of cross linked, polyethylene having at least 10% by weight of an inorganic filler therein, disposed upon at least a portion of its length. In one embodiment of the method, a body of cross-linkable thermoplastic polyethylene having at least 10% by weight of the inorganic filler therein is disposed upon the core and then cross-linked. In specific embodiments, the cross-linkable thermoplastic polyethylene is extruded onto the core. Cross linking of the thermoplastic polyethylene may be accomplished by incorporating an activatable cross linking agent into the thermoplastic polyethylene and then activating the cross linking agent after the thermoplastic polyethylene has been disposed upon the core. In one specifically preferred group of embodiments, the cross linking agent is a moisture activatable cross linking agent, and cross linking is accomplished by exposing the agent to moisture as for example by exposing the agent to a humid atmosphere. Silanes comprise one preferred group of moisture activatable cross-linking agents, and vinyl triethoxysilane is one specifically preferred moisture activatable cross-linking agent.

### BRIEF DESCRIPTION OF THE DRAWING

FIG. 1 is a cross-sectional view of an optical communication cable of the present invention.

### DETAILED DESCRIPTION OF THE INVENTION

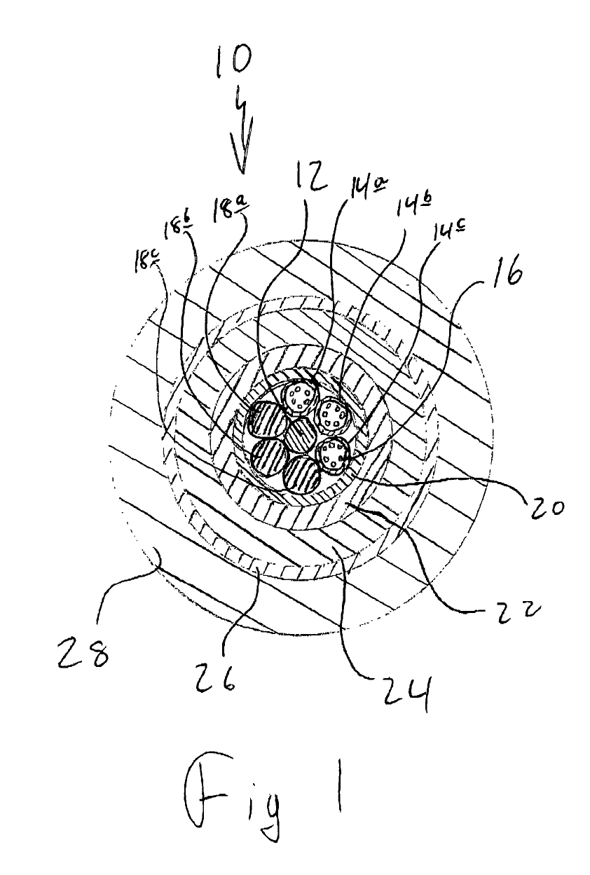

The present invention is directed to an optical communication cable having an increased resistance to dry band arcing, and to methods for manufacturing that cable. Referring now to FIG. 1, there is shown a cross-sectional view of a typical optical cable of the present invention; and it is to be understood that the principles of the present invention may be readily adapted to optical cables which are otherwise configured, as well as to electrical cables, digital data cables, telephone cables and other such cables which must be protected against dry band arcing.

FIG. 1 depicts a cross-sectional view of a typical optical cable 10 structured in accord with the principles of the present invention. The cable 10 of FIG. 1 is of the type referred to in the art as an All Dielectric Self Supporting (ADSS) cable. The cable 10 includes a central support member 12 which is typically formed from a fiber reinforced plastic. Disposed about the central member 12 are a plurality of buffer tubes 14a, 14b, 14c, and each buffer tube includes a plurality of optical fibers 16 disposed therein. In a typical embodiment, the space within the buffer tubes 14 between the fibers 16 is filled with a gel material. As depicted in FIG. 1, each of the buffer tubes 14 includes six optical fibers 16 therein; however, it is to be understood that the cable may include a larger or smaller number of fibers. As depicted in FIG. 1, the cable includes three buffer tubes 14a-14c, each having fibers 16 therein, and the remainder of the space about the central member 12 is filled by filler members 18a, 18b, 18c. These filler members typically are comprised of a polymeric material such as polyethylene or polypropylene and function to fill space not occupied by buffer tubes and the central support member. Depending upon the configuration of the optical cable, a larger number, or smaller number of filler members, or no filler members, may be present in the cable.

The central member 12 and buffer tubes 14, as well as any fillers 18, are wrapped in a water-blocking layer 20 which is generally comprised of a winding of a polyester tape such as a polyethyleneterephthalate (Mylar®) and a moisture-proof adhesive binder. Disposed about the moisture blocking layer 20 is an inner jacket member 22 typically comprised of a thermoplastic material such as medium density polyethylene (MDPE), nylon, or any other such flexible thermoplastic material. Disposed about the inner jacket 22 is a high strength layer 24 typically comprised of a winding of aramid yarn such as Kevlar®or glass fibers. This winding serves to strengthen the cable. Disposed about the high strength-winding layer 24 is another layer of moisture resistant material 26, and this layer is generally similar to the moisture-blocking layer 20.

All of the layers and elements of the cable 10 heretofore described are generally known in the art and incorporated into prior art cables, and as such, within the context of this disclosure, these layers constitute the core member of the cable. However, it is to be understood that within the context of this disclosure and the present invention, the “core member” as described and claimed herein is not restricted to the materials and configurations described in FIG. 1. Other cable configurations are known or obvious in view of the state of the art, and can be utilized as core members in the practice of the present invention. Within the context of this disclosure, a “core member” is to be understood to broadly include any cable portion which includes at least one optical fiber therein, and which has the jacket of the present invention, as will be described hereinbelow, disposed, or disposable about, at least a portion of its exterior surface.

As further depicted in FIG. 1, the core member of the cable 10, in accord with the principles of the present invention, includes an outer jacket 28 which is comprised of a cross-linked medium density polyethylene (MDPE) having an inorganic filler material present therein, typically in an amount of at least 10% by weight of the jacket. In some embodiments, the filler comprises 15-20% by weight of the jacket; and in one particular embodiment, the filler comprises 18% by weight of the jacket. While MDPE, including MDPE having filler materials therein, is known in the art and has been used as a protective layer in a variety of applications, including electrical and optical cables, the MDPE used in such prior art applications has generally been a non-cross linked thermoplastic material; and in any instance, prior art cables have not employed the fillers of the present invention. Cables of the prior art exhibit dry band arcing and do not secure the advantages of the present invention. In contrast, the cross-linked, thermosetting, filled jacket of the present invention exhibits a greatly decreased tendency toward dry band arcing.

While the present invention may be practiced using low-to-high density, cross-linked polyethylene, presently preferred embodiments employ cross-linked medium density polyethylene (MDPE). As is understood in the art, MDPE comprises an ethylene polymer having a specific density in the general range of 0.90-0.99 grams/cc. A preferred material used in the present invention has a density of approximately 0.955 grams/cc. In accord with the present invention, the cross-linked MDPE jacket further includes at least 10%, and in a preferred embodiment, 10% to 30% by weight of the jacket, of an inorganic filler. One particularly preferred filler material is MgO. Prior art fillers for cable jacketing were generally based upon alumina trihydrate (ATH), also known as hydrated Al₂O₃. In accord with the present invention, it has been found that superior resistance to dry band arcing occurs if the filler in the cross-linked MDPE has a very low content of ATH and a high content of MgO. Therefore, in a particularly preferred embodiment, the inorganic filler includes no more than 1% by weight of ATH, and a high concentration of MgO. The filler typically includes at least 75% by weight of MgO. The inorganic filler may include other materials, such as CaO, SiO₂, K₂O, Na₂O, Fe₂O₃ and other inorganic compounds in minor amounts. In a specific embodiment of the present invention, the inorganic filler comprises 18% by weight of the jacket material, and this filler includes, by weight, approximately 90% MgO and no more than 1% ATH. As is known in the cable art, the outermost portion of the jacket may include up to 3% carbon black having an average particle size of 20 nanometers. This material is typically added to the outermost portion of the jacket as it is being extruded or otherwise coated onto the core. The carbon black serves to increase the ultraviolet resistance of the cable. This carbon-containing layer may also be included in the cables of the present invention.

The cross-linked polyethylene jacket may be affixed to the core member by a variety of techniques as will be apparent to one of skill in the art. In one particularly preferred embodiment of the present invention, a body of thermoplastic MDPE is first disposed on the core member, as for example by extruding, dipping or the like, and this thermoplastic jacket is subsequently cross linked in situo to form an integral, cross-linked, thermosetting MDPE jacket.

Cross linking of the polyethylene may be implemented by any art-known technique such as radiation-induced cross linking by means of electron beams, gamma rays or the like; chemical cross linking with organic peroxides or other materials; free radical cross linking through reactive polymers and the like. In a particularly preferred embodiment of the present invention, cross-linking is accomplished through the use of an activatable cross-linking agent. Such agents, when activated by heat, radiation or exposure to materials such as water or chemical catalysts, cross link the polyethylene to convert it from a thermoplastic material to a cross-linked thermoset material.

One particularly preferred group of cross-linking agents having utility in the present invention comprises moisture activatable cross-linking agents. One class of such moisture activatable agents comprise silanes, and vinyl triethoxysilane is one specifically preferred silane based cross-linking agent. In a typical and preferred process of the present invention, a jacket of thermoplastic MDPE is extruded onto a core member and subsequently cured. In this regard, the feedstock MDPE resin (which includes the inorganic filler therein) is combined with approximately 2-7% by weight of the moisture-curing agent prior to extrusion. Union Carbide supplies a filled thermoplastic MDPE resin under the designation “DHDA-6750 Black,” and this material may be used in the present invention. Similar thermoplastic resins are available from Borealis of Sweden, or AEI of the United Kingdom. Extrusion is carried out via conventional techniques as employed with prior art thermoplastic jackets, and the resultant jacketed cable is stored in a high humidity atmosphere so as to cause the curing agent to cross link the MDPE outer jacket. Curing typically takes place over a 48-hour period in an oven at a temperature of approximately 150° F. Curing will occur over a longer period at lower humidities and/or temperatures. Curing can be ascertained by testing methods for determining if the material has achieved a “hot set” as said term is known in the art. Such techniques are well known in the art and include the “dog bone” elongation test.

Cross-linking may be accomplished by other techniques such as the use of organic peroxides, radiation, or reaction copolymerization, and all of such embodiments are within the scope of the present invention. However, because of simplicity of implementation, lower cost, decreased pollution and other environmental concerns, and compatibility with previously employed cable extrusion technologies, moisture activated cross linking reactions are particularly preferred for the practice of the present invention.

While the present invention has been described with specific reference to the fabrication of a particularly configured optical cable, it is to be understood that this invention may also be employed with equal advantage in any instance where an article must exhibit an increased resistance to the propagation of electrical arcs there across. In that regard, the present invention may be employed with advantage in the fabrication of electrical cables on overhead power lines, fluid delivery systems and the like. Also, the cross-linked polyethylene jacket material will also find significant utility as an insulating coating for noncable structures. Therefore, it is to be understood that numerous modifications and variations of the present invention will be readily apparent to one of skill in the art. The foregoing drawing, discussion and description are illustrative of particular embodiments of the invention; but they are not limitations upon the practice thereof. It is the following claims, including all equivalents, which define the scope of the invention.

What is claimed is:

1. A method of making an optical communication cable having an increased resistance to dry band arcing, said method comprising the steps of:
providing an elongated core member having at least one optical fiber extending along the length thereof; and
disposing a jacket on at least a portion of the length of said core member, said jacket comprising a body of cross linked, polyethylene having at least 10% by weight of an inorganic filler therein.

2. The method of claim 1, wherein the step of disposing said jacket on said core comprises disposing a body of cross linkable, thermoplastic polyethylene having at least 10% by weight of an inorganic filler therein, on said core; and then cross linking said body of cross linkable, thermoplastic polyethylene.

3. The method of claim 2, wherein the step of disposing said body of cross-linkable, thermoplastic polyethylene onto said core comprises extruding said body onto said core.

4. The method of claim 2, wherein said cross linkable body of thermoplastic polyethylene includes an activatable cross linking agent therein, and wherein the step of cross linking said body comprises activating said cross linking agent so as to crosslink said body of polyethylene.

5. The method of claim 4, wherein said activatable cross linking agent is a moisture activatable cross linking agent, and wherein said step of activating said activatable cross linking agent comprises exposing said agent to moisture.

6. The method of claim 5, wherein the step of exposing said agent to moisture comprises exposing said agent to a humid atmosphere.

7. The method of claim 5, wherein said moisture activatable cross-linking agent is a silane.

8. The method of claim 7, wherein said silane is vinyl triethoxysilane.

9. The method of claim 1, wherein said inorganic filler comprises at least 75% by weights MgO.

10. The method of claim 1, wherein said inorganic filler comprises at least 90% by weights MgO.

11. The method of claim 1, wherein said inorganic filler comprises, by weight, no more than 1% Al₂O₃.

12. The method of claim 1, wherein said polyethylene is medium density polyethylene.

13. The method of claim 1, wherein said inorganic filler comprises, on a weight basis, 10-30% of said jacket.

14. The method of claim 1, wherein said inorganic filler comprises, on a weight basis, 18% of said jacket.

15. An optical communication cable having an increased resistance to dry band arcing, said cable comprising:
an elongated core member having at least one optical fiber extending along the length thereof; and
a jacket covering at least a portion of the length of said core member, said jacket being comprised of a cross linked body of polyethylene having at least 10% by weight of an inorganic filler therein.

16. The cable of claim 15, wherein said inorganic filler comprises at least 75% by weight MgO.

17. The cable of claim 15, wherein said inorganic filler includes, by weight, no more than 1% Al₂O₃.

18. The cable of claim 15, wherein said cross-linked polyethylene is a moisture cross-linked polyethylene.

19. The cable of claim 15, wherein said inorganic filler comprises, by weight, 10-30% of said cross-linked medium density polyethylene.

20. The cable of claim 15, wherein said polyethylene is a medium density polyethylene.
